(19) United States
(12) Patent Application Publication
(10) Pub. No.: US 2011/0150072 A1
(43) Pub. Date: Jun. 23, 2011

(54) ENCODING METHOD, DECODING METHOD AND APPARATUS THEREOF

(76) Inventor: Ki-Hun HAN, Seoul (KR)

(21) Appl. No.: 12/883,735

(22) Filed: Sep. 16, 2010

(30) Foreign Application Priority Data
Dec. 21, 2009 (KR) 10-2009-0127738

(51) Int. Cl. H04N 7/26

(52) U.S. Cl. 375/240.01; 375/E07.026

(57) ABSTRACT

Video encoding and decoding methods and devices are provided which can efficiently switch a lossy mode and a lossless mode to each other. The video encoding device includes: a prediction section that generates a residual signal which is a difference between an input image and prediction values acquired by performing one or more of temporal prediction and spatial prediction on macro blocks of the input image; a transformation and quantization section that performs or skips transformation and quantization on the residual signal depending on mode information; an entropy-coding section that entropy-codes the residual signal output from the transformation and quantization section to generate a bitstream; a lossless-mode QP range determining section that determines a lossless-mode QP range using an amount of bits generated by the entropy-coding section and a quantization coefficient (QP); and a mode determining section that compares a current QP value with the determined lossless-mode QP range to determine one of a lossy mode and a lossless mode and transmits information on the determined mode to the transformation quantization section. Accordingly, by designating a lossless-mode quantization coefficient range, it is possible to reduce an amount of bits necessary for switching a lossy mode and a lossless mode.

### CROSS REFERENCE

This application is based on and claims priority under 35 USC 119 from Korean Patent Application No. 10-2009-0127738, filed on Dec. 21, 2009.

### BACKGROUND

1. Field of the Invention

The present invention relates to encoding method and device and decoding method and device, and more particularly, to encoding method and device and decoding method and device, which can efficiently switch a lossy mode and a lossless mode to each other.

2. Description of the Related Art

H.264/AVC is a video encoding and decoding standard prepared by the VCEG (Video Coding Experts Group) of ITU-T and the MPEG (Moving Picture Experts Group) of ISO/IEC and is also a digital video codec standard having a very high compression ratio.

The H.264/AVC supports both lossy and lossless video encoding/decoding and thus can encode and decode a slice in which a lossy mode and a lossless mode coexist. That is, the H.264/AVC standard allows independently encoding/decoding macro blocks in a slice in a lossy mode and a lossless mode.

FIG. 1 is a diagram illustrating an example of an image in which a lossy mode area and a lossless mode area coexist. Referring to FIG. 1, an important area 12, which is desired by a user or a contents provider or from which information should not be lost, in an image 10 to be encoded can be encoded and decoded in a lossless mode and the other area 14 can be encoded and decoded in a lossy mode.

In the H.264, a bypass flag (qpprime_y_zero_transform_bypass_flag) and a quantization coefficient QP are used to switch the lossy mode and the lossless mode to each other. When the bypass flag is set to 1 and the QP value is 0, the encoding and decoding is performed in the lossless mode. Otherwise, that is, when the QP value is not 0 or when the QP value is 0 but the bypass flag is not set to 1, the encoding and decoding is performed in the lossy mode.

FIG. 2 is a block diagram illustrating the configuration of a lossless-mode encoding device in the H.264.

Referring to FIG. 2, the lossless-mode encoding device includes a prediction section 22, a transformation and quantization section 24, and an entropy-coding section 26. Here, the lossless-mode encoding device skips the transformation and quantization section 24 performing transformation and quantization processes to avoid the loss of information.

That is, the lossless encoding is performed by skipping the transformation and quantization and performing the entropy-coding on a residual signal generated after intra prediction or motion estimation in the prediction section 22.

In the lossy-mode encoding, a bit rate and image quality are determined in proportion to the QP value. A 52-step QP range of 0 to 51 is used in the H.264. The encoding and decoding with a high bit rate and high image quality can be performed when the QP value is small, but the encoding and decoding with low bit rate and low image quality when the QP value is large.

Test conditions and test results of a test for comparing compression ratios of the lossless encoding and the lossy encoding in the range of QP 0 to QP 3 corresponding to near-lossless in the H.264 will be described below.

First, the test conditions are shown in Table 1.

TABLE 1

| | | | Coding | |
|---|---|---|---|---|
| Sequences | | | frames | Coding Options |
| YUV 4:2:0 | QCIF | News | 300 | Rate-Optimization |
| | (176 × 144) | Container | 300 | used, |
| | | Foreman | 300 | CABAC entropy |
| | | Silent | 300 | coding, |
| | CIF | Paris | 300 | only Intra frames |
| | (352 × 288) | Mobile | 300 | |
| | | Tempete | 260 | |
| | 4CIF | City | 300 | |
| | (704 × 576) | Crew | 300 | |
| | | Harbour | 300 | |
| | | Ice | 300 | |

As shown in Table 1, images of YUV 4:2:0 with various resolutions of QCIF to 4CIF are tested and the test results thereof are arranged in Table 2.

TABLE 2

| | | Lossy | Lossy | Lossy | |
|---|---|---|---|---|---|
| Sequences | Lossless | (QP = 0) | (QP = 1) | (QP = 2) | Lossy (QP = 3) |
| News | 2.048 | 1.523 | 1.685 | 1.820 | 1.909 |
| Container | 1.976 | 1.487 | 1.618 | 1.743 | 1.830 |
| Foreman | 1.892 | 1.411 | 1.531 | 1.652 | 1.740 |
| Silent | 1.714 | 1.317 | 1.456 | 1.567 | 1.655 |
| Paris | 1.712 | 1.239 | 1.384 | 1.483 | 1.557 |
| Mobile | 1.089 | 0.857 | 0.915 | 0.969 | 1.017 |
| Tempete | 1.430 | 1.108 | 1.216 | 1.301 | 1.368 |
| City | 2.025 | 1.548 | 1.762 | 1.897 | 2.004 |
| Crew | 3.454 | 3.039 | 3.250 | 3.459 | 3.592 |
| Harbour | 1.952 | 1.505 | 1.765 | 1.908 | 2.019 |
| Ice | 5.017 | 4.012 | 4.271 | 4.544 | 4.794 |
| Average | 2.210 | 1.731 | 1.896 | 2.031 | 2.135 |

As can be seen from Table 2, the lossy encoding corresponding to the range of QP 0 to QP 3 has a compression ratio smaller than that of the lossless encoding.

The lossless encoding is more efficient than the lossy encoding with a compression ratio lower than that of the lossless encoding in view of the compression ratio and the image quality.

Therefore, the lossy encoding with the QP 4 or higher is preferably performed to obtain a higher encoding efficiency. In other words, as shown in FIG. 1, when the lossy-mode area and the lossless-mode area coexist in an image, it is necessary to change QP 4 or higher to QP 0 so as to switch the lossy mode to the lossless mode.

When the difference in QP value is greater, a relatively large amount of bits is required for encoding a value of mb_qp_delta. Accordingly, the method of switching the lossy mode and the lossless mode in the H.264 is inefficient. That is, since an inefficient QP range in view of the compression ratio is used, the method of switching the lossy mode and the lossless mode at the time of encoding a video is inefficient.

### SUMMARY

An advantage of some aspects of the invention is that it provides video encoding and decoding methods and devices, which can reduce an amount of bits necessary for switching the lossy mode and the lossless mode by designating a lossless-mode quantization coefficient range and use a new quantization coefficient range.

Another advantage of some aspects of the invention is that it provides video encoding and decoding methods and devices, which can provide a feeling of visual satisfaction and desired information to a user and can allow video encoding and/or decoding efficient in compression ratio, by encoding and/or decoding an important area, which is desired by a contents provider or a user or from which information has not to be lost, in an image in a lossless mode and encoding and/or decoding the other area in a lossy mode.

Other advantages of the invention will be easily understood from the following description.

According to an aspect of the invention, there is provided an encoding device including: a prediction section that generates a residual signal which is a difference between an input image and prediction values acquired by performing one or more of temporal prediction and spatial prediction on macro blocks of the input image; a transformation and quantization section that performs or skips transformation and quantization on the residual signal depending on mode information; an entropy-coding section that entropy-codes the residual signal output from the transformation and quantization section to generate a bitstream; a lossless-mode QP range determining section that determines a lossless-mode QP range using an amount of bits generated by the entropy-coding section and a quantization coefficient (QP); and a mode determining section that compares a current QP value with the determined lossless-mode QP range to determine one of a lossy mode and a lossless mode and transmits the mode information on the determined mode to the transformation quantization section.

The entropy-coding section may entropy-code information on the lossless-mode QP range determined by the lossless-mode QP range determining section to generate a bitstream.

The lossless-mode QP range determining section may compare an average amount of bits necessary for lossless-mode encoding with an average amount of bits necessary for lossy-mode encoding of each QP in the course of encoding and may determine the lossless-mode QP range so that one or more QPs in the lossy mode having an amount of bits greater the average amount of bits necessary for the lossless-mode encoding belong to the lossless-mode QP range. The lossless-mode QP range determining section determines the lossless-mode QP range so that one or more QPs in the lossy mode having rate-distortion cost greater than that in the lossless mode belong to the lossless-mode QP range.

Alternatively, the lossless-mode QP range determining section may encode a slice or frame to which the macro block in the lossless mode and the lossy mode based on one or more QP values and may then compare the amounts of bits thereof to determine the lossless-mode QP range. The mode determining section may determine a mode for the macro block using the lossless-mode QP range, and the transformation and quantization section may perform or skip the transformation and quantization on the macro block depending on the mode determined by the mode determining section.

The mode determining section may redefine a QP table by removing the lossless-mode QP range and may determine the mode on the basis of the redefined QP table. The mode determining section may rearrange a QP range in the lossy mode on the basis of the redefined QP table and may determine the mode using the rearranged QP table.

The input image may be an H.264/AVC image in which a lossy-mode area and a lossless-mode area coexist.

According to another aspect of the invention, there is provided a decoding device including: an entropy-decoding section that receives and entropy-decodes a bitstream including lossless-mode QP range information and a residual signal; a lossless-mode QP range determining section that determines a lossless-mode QP range on the basis of the decoded lossless-mode QP range information; a mode determining section that compares a QP value of the bitstream with the lossless-mode QP range determined by the lossless-mode QP range determining section to determine one of a lossy mode and a lossless mode; an inverse transformation and quantization section that performs or skips inverse transformation and inverse quantization on the entropy-decoded residual signal depending on the mode determined by the mode determining section; and a compensation section that adds a predicted value resulting from one or more of spatial compensation and temporal compensation to the residual signal output from the inverse transformation and inverse quantization section to generate a reconstructed image.

The reconstructed image may be an H.264/AVC image in which a lossy-mode area and a lossless-mode area coexist.

According to another aspect of the invention, there is provided an encoding method in an encoding device that encodes an input image to generate a bitstream and a recording medium having recorded thereon a program for carrying out the encoding method.

The encoding method includes: generating a residual signal which is a difference between an input image and prediction values acquired by performing one or more of temporal prediction and spatial prediction on macro blocks of the input image; performing or skipping transformation and quantization on the residual signal depending on mode information; entropy-coding the resultant residual signal to generate a bitstream; determining a lossless-mode QP range using an amount of bits generated in the step of entropy-coding and a quantization coefficient (QP); and comparing a current QP value with the determined lossless-mode QP range to determine one of a lossy mode and a lossless mode and transmitting information on the determined mode to the transformation quantization section. The encoding method may further include a step of entropy-coding information on the lossless-mode QP range to generate a bitstream.

The step of determining the lossless-mode QP range may include comparing an average amount of bits necessary for lossless-mode encoding with an average amount of bits necessary for lossy-mode encoding of each QP in the course of encoding and determining the lossless-mode QP range so that one or more QPs in the lossy mode having an amount of bits greater the average amount of bits necessary for the lossless-mode encoding belong to the lossless-mode QP range. The step of determining the lossless-mode QP range may include determining the lossless-mode QP range so that one or more QPs in the lossy mode having rate-distortion cost greater than that in the lossless mode belong to the lossless-mode QP range.

Alternatively, the step of determining the lossless-mode QP range may include encoding a slice or frame to which the macro block in the lossless mode and the lossy mode based on one or more QP values and comparing the amounts of bits thereof to determine the lossless-mode QP range. The step of determining a mode may include determining a mode for the macro block using the lossless-mode QP range, and the step of performing or skipping transformation and quantization and the step of entropy-coding may be finally performed on the macro block.

The step of determining a mode may include redefining a QP table by removing the lossless-mode QP range and determining the mode on the basis of the redefined QP table. The step of determining a mode may include rearranging a QP range in the lossy mode on the basis of the redefined QP table and determining the mode using the rearranged QP table.

The input image may be an H.264/AVC image in which a lossy-mode area and a lossless-mode area coexist.

According to still another aspect of the invention, there is provided a decoding method in a decoding device that receives and decodes a bitstream including lossless-mode QP range information and a residual signal to generate a reconstructed image and a recording medium having recorded thereon a program for carrying out the decoding method.

The decoding method includes: entropy-decoding the bitstream; determining a lossless-mode QP range on the basis of the entropy-decoded lossless-mode QP range information; comparing a QP value of the bitstream with the determined lossless-mode QP range to determine one of a lossy mode and a lossless mode; performing or skipping inverse transformation and inverse quantization on the decoded residual signal depending on the determined mode; and adding a predicted value resulting from one or more of spatial compensation and temporal compensation to the residual signal having been subjected to the step of performing or skipping inverse transformation and inverse quantization to generate a reconstructed image. The reconstructed image may be an H.264/AVC image in which a lossy-mode area and a lossless-mode area coexist.

Other aspects, features, and advantages will become apparent from the accompanying drawings, the appended claims, and the detailed description.

According to the above-mentioned configurations, it is possible to reduce an amount of bits necessary for switching the lossy mode and the lossless mode by designating a lossless-mode quantization coefficient range and to use a new quantization coefficient range.

It is also possible to provide a feeling of satisfaction and desired information to a user and to allow video encoding and/or decoding efficient in compression ratio, by encoding and/or decoding an important area, which is desired by a contents provider or a user or from which information has not to be lost, in an image in a lossless mode and encoding and/or decoding the other area in a lossy mode.

### BRIEF DESCRIPTION OF THE DRAWINGS

FIG. 1 is a diagram illustrating an example of an image in which a lossy-mode area and a lossless-mode area coexist.

FIG. 2 is a block diagram illustrating the configuration of a lossless-mode encoding device in the H.264.

FIG. 3 is a block diagram illustrating the configuration of an encoding device according to an embodiment of the invention.

FIG. 4 is a diagram illustrating a method of determining a lossless-mode QP range according to the embodiment of the invention.

FIG. 5 is a diagram illustrating a method of determining a lossless-mode QP range according to another embodiment of the invention.

FIG. 6 is a diagram illustrating an example of a rearranged QP range according to the embodiment.

FIG. 7 is a block diagram illustrating the configuration of a decoding device according to the embodiment of the invention.

FIG. 8 is a flow diagram illustrating an encoding method according to the embodiment of the invention.

FIG. 9 is a flow diagram illustrating a decoding method according to the embodiment of the invention.

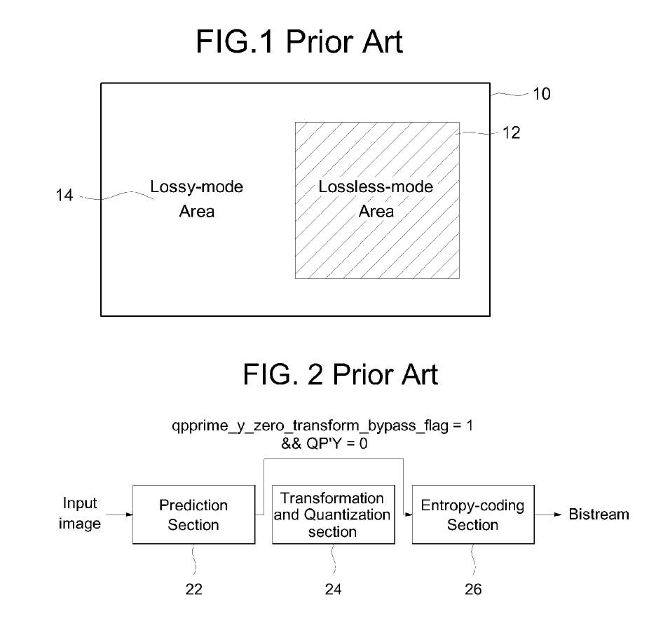

### DESCRIPTION OF EXEMPLARY EMBODIMENTS

The invention can be variously modified in various forms and specific embodiments will be described and shown in the drawings. However, the embodiments are not intended to limit the invention, but it should be understood that the invention includes all the modifications, equivalents, and replacements belonging to the spirit and the technical scope of the invention. When it is determined that detailed description of known techniques associated with the invention makes the gist of the invention obscure, the detailed description will be omitted.

Terms such as “first” and “second” can be used to describe various elements, but the elements are not limited to the terms. The terms are used only to distinguish one element from another element.

The terms used in the following description are used to merely describe specific embodiments, but are not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded. Terms, “unit”, “-er(-or)”, “module”, and the like, described in the specification mean a unit for performing at least one function or operation and can be embodied by hardware, by software, or by a combination of hardware and software.

In the drawings which are referred to in describing the exemplary embodiments of the invention, like elements are referenced by like reference numerals and description thereof is not repeated. Then it is determined that detailed description of known techniques associated with the invention makes the gist of the invention obscure, the detailed description will be omitted.

The exemplary embodiments of the invention will be described below in detail with reference to the accompanying drawings.

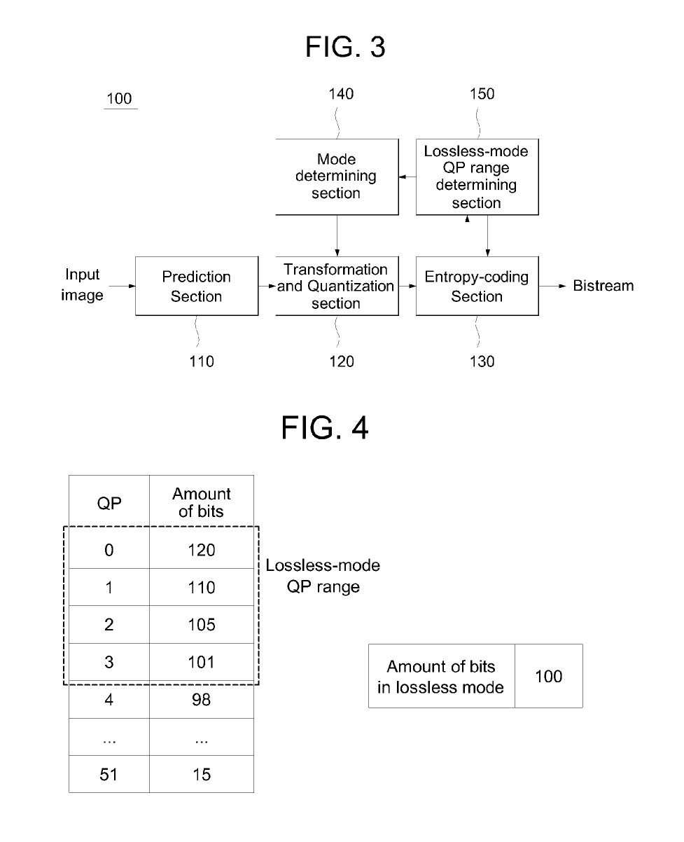

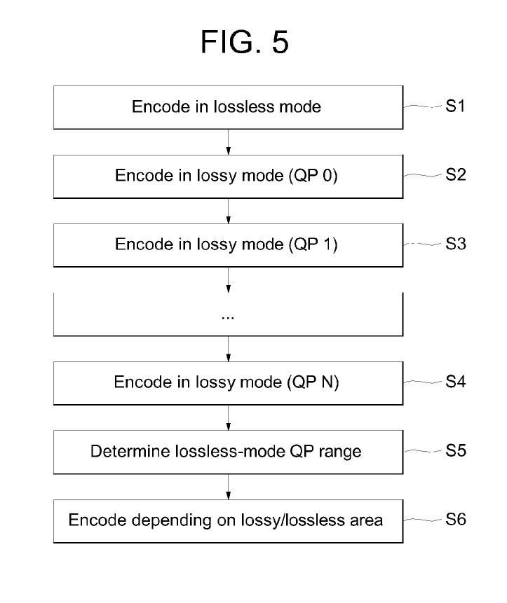

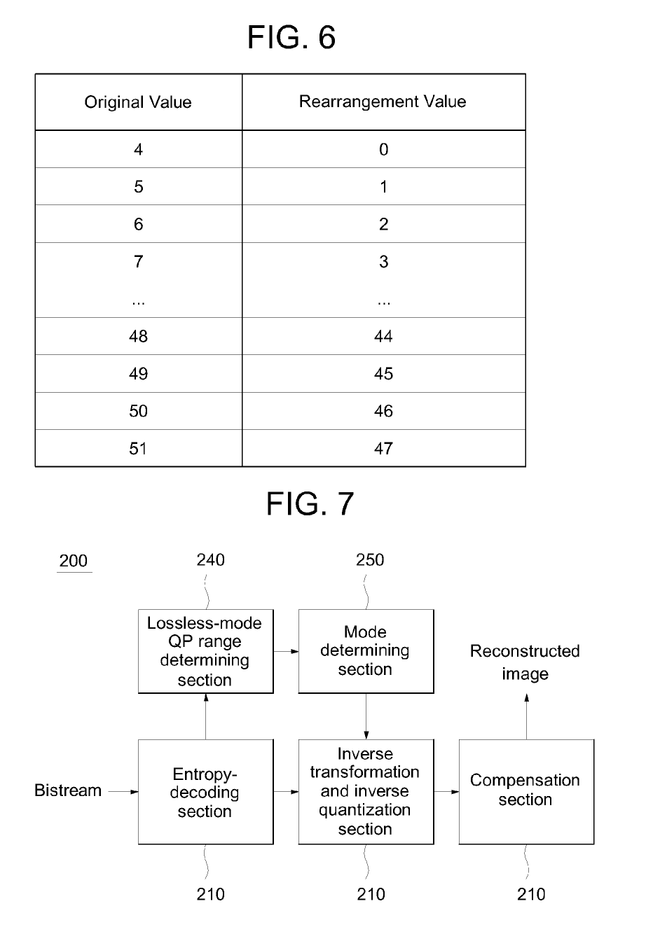

FIG. 3 is a block diagram illustrating the configuration of an encoding device according to an embodiment of the invention. FIG. 4 is a diagram illustrating a method of determining a lossless-mode QP range according to the embodiment of the invention. FIG. 5 is a diagram illustrating a method of determining a lossless-mode QP range according to another embodiment of the invention. FIG. 6 is a diagram illustrating an example of a rearranged QP range according to the embodiment.

Referring to FIG. 3, an encoding device 100 according to an embodiment of the invention includes a prediction section 110, a transformation and quantization section 120, an entropy-coding section 130, a lossless-mode QP range determining section 150, and a mode determining section 140.

When the encoding device 100 according to the embodiment of the invention encodes an input image, a layer (for example, a slice layer) higher than a macro block layer encoding an actual residual signal designates a QP range to be encoded in a lossless mode. The macro block layer encodes the input image in the lossless mode when a QP value belongs to the designated QP range, encodes the input image in a lossy mode when the QP value does not belong to the designated QP range, and generates and outputs a bitstream. Accordingly, it is possible to relatively reduce a QP difference at the time of switching the lossy mode and the lossless mode and to reduce an amount of bits corresponding thereto.

The prediction section 110 performs a spatial prediction such as an intra prediction for removing intra redundancy of the input image from each macro block or performs a temporal prediction such as a motion estimation for removing inter redundancy between frames, and generates a residual signal which is a difference between the input image and a prediction value.

The intra prediction is a kind of spatial prediction and removes the spatial redundancy from pixels of a current block in the same image using pixels of the peripheral blocks. By using plural prediction modes using the directionality of a spatial area, it is possible to minimize the residual signal to actually be encoded, thereby improving the compression performance. For example, SAD (Sum of Absolute Difference) or SAID (Sum of Absolute Transform Difference) between various prediction blocks and an original block is calculated and a mode having the smallest value may be selected as the optimal prediction mode.

The motion estimation means to estimate to what position each object or a process unit block in a video moves in temporally-subsequent frames. For example, a block having the smallest luminance difference between the pixels of a macro block and peripheral macro blocks of several subsequent frames is retrieved to determine a motion vector.

The transformation and quantization section 120 performs or skips the transformation and quantization on the residual signal depending on the signal output from the mode determining section 140 to be described later.

The entropy-coding section 130 entropy-codes the output signal of the transformation and quantization section 120 to generate a bitstream and sends the generated bitstream to the lossless-mode QP range determining section 150. The entropy-coding section 130 entropy-codes lossless-mode QP range information sent from the lossless-mode QP range determining section 150 to generate a bitstream.

The lossless-mode QP range determining section 150 determines the lossless-mode QP range on the basis of the amount of bits sent from the entropy-coding section 130 and the QP value and sends the generated lossless-mode QP range to the mode determining section 140. The lossless-mode QP range determining section 150 sends the determined lossless-mode QP range information to the entropy-coding section 130.

To determine the lossless-mode QP range, the following methods can be efficiently used.

In an method, the quantization coefficients QP in the lossy mode greater than the amount of bit in the lossless mode are determined as belonging to the lossless-mode QP range, in consideration of an average amount of bits required for encoding a macro block in the lossy mode and an average amount of bits required for encoding the macro block in the lossless mode by the QPs. For example, as shown in FIG. 4, the average amount of bits in the lossless mode is 100. Accordingly, the QPs, that is, QP0 to QP3 in the lossy mode of which the average amount of bits is greater than 100 can be determined as belonging to the lossless-mode QP range.

In another method, the concept of rate-distortion optimization (RDO) can be used. Since the amount of bits in the lossy mode is smaller than the amount of bits in the lossless mode but a distortion exists between an original image and a reconstructed image, the QPs of which the rate-distortion cost (RDcost) is greater than that in the lossless mode can be determined to belonging to the lossless-mode QP range. For example, referring to FIG. 4, the amount of bits in QP4 is 98 smaller than the amount of bits, 100, in the lossless mode and no distortion exists in case of the lossless mode but a distortion exists in case of QP4. Accordingly, the RDcost of QP4 may be greater than the RDcost in the lossless mode in consideration of the distortion. In this case, QP4 can be determined as belonging to the lossless-mode QP range.

The amount of bits of each QP and the amount of bits in the lossless mode shown in FIG. 4 may contain information on previous encoding. Alternatively, an average amount of bits corresponding to the QP value with which a macro block is encoded may be updated and stored whenever the corresponding macro block is encoded at the time of encoding a current slice. When the corresponding macro block is encoded in the lossless mode, the amount of bits in the lossless mode is updated and stored.

In still another method, a current frame or slice may be encoded in various modes to find the optimal encoding method.

Referring to FIG. 5, a current slice is encoded in the lossless mode (step S1) and is encoded in the lossy mode by one or more of QP 0 to QP N (steps S2 to S4). The amounts of bits of the QPs and the amount of bit in the lossless mode are calculated and compared to determine the lossless-mode QP range (step S5). Finally, the current slice is divided into a lossless-mode area and a lossy-mode area and the divided areas are encoded in the lossless mode and the lossy mode, respectively (step S6).

The lossless-mode QP range determining section 150 can determine the lossless-mode QP range using one or more of the above-mentioned methods.

The lossless-mode QP range determined by the lossless-mode QP range determining section 150 corresponds to the lossless-mode QP range to be used in the current slice or frame or a subsequent slice or frame. For example, according to the lossless-mode QP range determining method shown in FIG. 5, when the current slice or frame is multiply encoded in the lossless mode and the lossy mode for one or more QPs, it influences the determination of the lossless-mode QP range to be considered at the time of finally encoding the current slice or frame (the encoding depending on the lossy and lossless area shown in step S6 of FIG. 5).

The mode determining section 140 compares the lossless-mode QP range sent from the lossless-mode QP range determining section 150 and the current QP value, determines the lossless mode when the current QP belongs to the lossless-mode QP range, determines the lossy mode when the current QP does not belong to the lossless-mode QP range, and then sends the resultant to the transformation and quantization section 120.

In the switching of the lossy mode and the lossless mode used in the existing H.264, the lossless mode is determined only when the bypass flag is set to 1 and the QP value is 0, and the lossy mode is determined otherwise. However, in this case, since the QP difference should be great at the time of switching the lossy mode and the lossless mode to each other to avoid the QP area having a lower compression ratio than in the lossless mode from being encoded, the corresponding amount of bits is great. However, according to this embodiment, since a layer higher than the macro block in which an actual residual signal is encoded determines the lossless-mode QP range and the encoding is performed in the lossless mode for the QPs in the determined lossless-mode QP range, it is possible to relatively reduce the QP difference at the time of switching the lossy mode and the lossless mode, thereby reducing the corresponding amount of bits.

In the encoding device 100 according to this embodiment, it is assumed that the lossless-mode QP range is determined to 0 to n. In the method employed in the existing H.264, since 0 should be given as the QP value at the time of switching the lossy mode with QP (n+1) to the lossless mode, the QP value difference is n+1. However, according to this embodiment, since n has only to be given as the QP value, the QP value difference is 1, thereby reducing the amount of bits required for switching the mode.

The mode determining section 140 can redefine a QP table on the basis of the lossless-mode QP range information sent from the lossless-mode QP range determining section 150.

For example, it is assumed the lossless-mode QP range is determined to 0 to 3. Then, when the QP value belongs to 0 to 3, the subsequent slice or frame is not subjected to the transformation and quantization. Therefore, by removing the QP value belonging to the lossless-mode QP range from the QP table, it is possible to reduce the number of steps of the QP range. That is, by using the QP range of QP 4 to QP 51 instead of the QP range of QP 0 to QP 51 in the existing H.264, it is possible to reduce the calculation amount or the amount of bits.

The original QP values 4 to 51 may be rearranged to 0 to 47 as shown in FIG. 6 and the rearranged values may be used.

FIG. 7 is a block diagram illustrating the configuration of a decoding device according to an embodiment of the invention.

Referring to FIG. 7, the decoding device 200 according to an embodiment of the invention includes an entropy-decoding section 210, an inverse transformation and inverse quantization section 220, a compensation section 230, a lossless-mode QP range determining section 240, and a mode determining section 250.

When the decoding device 200 according to this embodiment decodes an input bitstream, a layer (for example, a slice layer) higher than the macro block layer decoding an actual residual signal determines the lossless mode QP range on the basis of the lossless-mode QP range information contained in the bitstream. The macro block layer decodes the input bitstream in the lossless mode when the QP value belongs to the determined QP range, decodes the input bitstream in the lossy mode when the QP value does not belong to the determined QP range, and generates and outputs a reconstructed image. Accordingly, it is possible to relatively reduce the QP difference at the time of switching the lossy mode and the lossless mode to each other, thereby reducing the corresponding amount of bits.

The entropy-decoding section 210 entropy-decodes the input bitstream, sends the residual signal to the inverse transformation and inverse quantization section 220, and sends the lossless-mode QP range information to the lossless-mode QP range determining section 240.

The lossless-mode QP range determining section 240 determines the lossless-mode QP range on the basis of the lossless-mode QP range information sent from the entropy-decoding section 210.

The mode determining section 250 compares the current QP value with the lossless-mode QP range determined by the lossless-mode QP range determining section 240 to determine the lossy mode or the lossless mode and sends the determined mode to the inverse transformation and inverse quantization section 220.

The lossless-mode QP range determining section 150 of the encoding device 100 determines the lossless-mode QP range on the basis of the amounts of bits of the QPs and the amount of bits of the lossless mode, but the lossless-mode QP range determining section 240 of the decoding device 200 determines the lossless-mode QP range by only decoding the information (bits corresponding to the lossless-mode QP range) sent from the encoding device 100.

The inverse transformation and inverse quantization section 220 performs or skips the inverse transformation and inverse quantization on the residual signal sent from the entropy-decoding section 210 depending on the signal sent from the mode determining section 250.

The compensation section 230 adds a predicted value based on the spatial compensation and/or the temporal compensation to the residual signal output from the inverse transformation and inverse quantization section 220 and generates and outputs a reconstructed image.

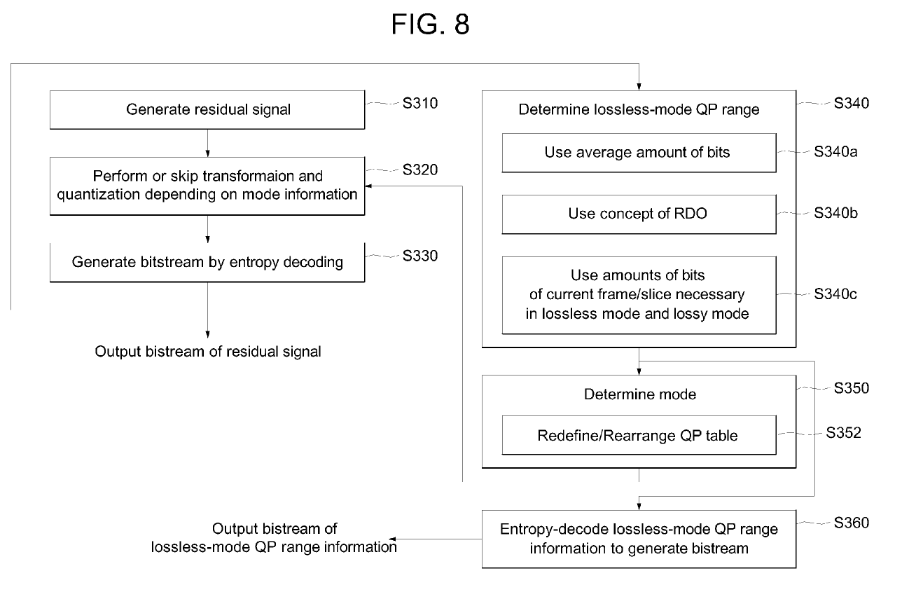

FIG. 8 is a flow diagram illustrating an encoding method according to an embodiment of the invention. The respective steps described below can be carried out by the respective constituent elements of the encoding device, but are described as being carried out by the encoding device for the purpose of convenient explanation.

The encoding device generates and outputs a residual signal which is a difference between an input image and a prediction value acquired by performing the spatial and/or temporal prediction on the input image (step S310).

The transformation and quantization is performed on the residual signal or is skipped depending on the mode (the lossy mode or the lossless mode) determined on the basis of the QP value (step S320). The transformation and quantization may be performed in the lossy mode and be skipped in the lossless mode.

The residual signal output from the transformation and quantization section is entropy-coded to generate a bitstream (step S330).

The lossless-mode QP range is determined using the QP values and the amount of bits generated when the residual signal is entropy-coded in step S330 (step S340).

In step S340a, all the QPs in the lossy mode having an amount of bits greater than that in the lossless mode are determined as belonging to the lossless-mode QP range in consideration of an average amount of bits required for the lossy-mode encoding and an average amount of bits required for the lossless-mode encoding.

In step S340b, even when the average amount of bits required for the lossy-mode encoding is not greater than the average amount of bits required for the lossless-mode encoding, the QPs having a rate-distortion cost (RDcost) greater than that in the lossless mode is determined as belonging to the lossless-mode QP range using the concept of rate-distortion optimization.

In step S340c, the encoding result in the lossy mode based on one or more QP values is compared with the encoding result in the lossless mode on the current frame or slice to determine the lossless-mode QP range.

When the lossless-mode QP range is determined in step S340, the lossy mode or the lossless mode is determined depending on whether the QP value in the slice or frame to be encoded belongs to the lossless-mode QP range (step S350). The lossless mode is determined when the QP value belongs to the lossless-mode QP range, and the lossy mode is determined when the QP value does not belong to the lossless-mode QP range.

Here, a subsequent slice or frame may be a target to be encoded or the current slice or frame having been subjected to the processes of steps S310 to S330 may be a target to be encoded.

The QP table is redefined by removing the lossless-mode QP range at the time of determining the mode, and the mode can be determined on the basis of the redefined QP table (step S352). The lossy-mode QP range may be rearranged on the basis of the redefined QP table.

When the current slice or frame is a target to be encoded, the processes of steps S320 to S330 are performed again depending on the mode determined in step S350 to generate and output a final bitstream.

The information corresponding to the lossless-mode QP range determined in step S340 is generated and output as a bitstream by the entropy-coding (step S360).

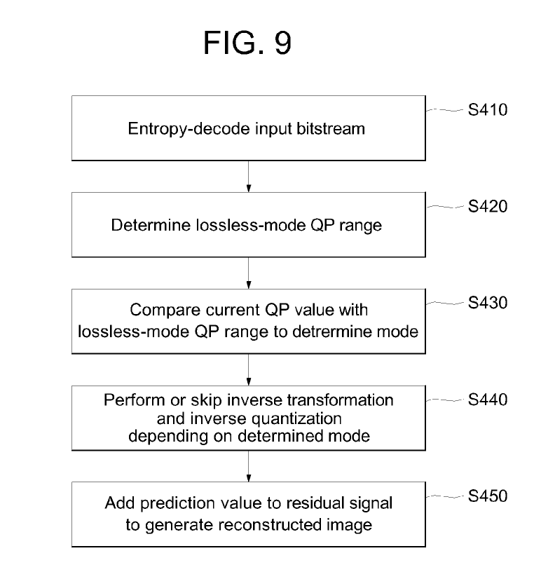

FIG. 9 is a flow diagram illustrating a decoding method according to an embodiment of the invention. The respective steps described below can be carried out by the respective constituent elements of the decoding device, but are described as being carried out by the decoding device for the purpose of convenient explanation.

The decoding device entropy-decodes an input bitstream and divides the input bitstream into the residual signal and the lossless-mode QP range information (step S410).

The lossless-mode QP range is determined on the basis of the lossless-mode QP range information (step S420), and the current QP value is compared with the determined lossless-mode QP range to determine the mode (the lossy mode or the lossless mode) (step S430).

The inverse transformation and inverse quantization is performed or skipped on the residual signal depending on the determined mode (step S440).

A prediction value resulting from the spatial compensation and/or the temporal compensation is added to the residual signal sent from the inverse transformation and inverse quantization section to generated and output a reconstructed image (step S450).

The encoding method and/or decoding method described above may be carried out in a time-series automated procedure by a software program built in the encoding device and/or the decoding device. Codes and code segments of the program will be easily obtained by programmers skilled in the art. The program can be stored in a computer-readable recording medium and can be read and executed by a computer to embody the above-mentioned method. Examples of the recording medium include a magnetic recording medium, an optical recording medium, and a carrier wave medium.

While the invention has been described with reference to the exemplary embodiments, it will be understood by those skilled in the art that the invention can be modified and changed in various forms without departing from the spirit and scope of the invention described in the appended claims.

What is claimed is:

1. An encoding device comprising:
a prediction section that generates a residual signal which is a difference between an input image and prediction values acquired by performing one or more of temporal prediction and spatial prediction on macro blocks of the input image;
a transformation and quantization section that performs or skips transformation and quantization on the residual signal depending on mode information;
an entropy-coding section that entropy-codes the residual signal output from the transformation and quantization section to generate a bitstream;
a lossless-mode QP range determining section that determines a lossless-mode QP range using an amount of bits generated by the entropy-coding section and a quantization coefficient (QP); and
a mode determining section that compares a current QP value with the determined lossless-mode QP range to determine one of a lossy mode and a lossless mode and transmits the mode information on the determined mode to the transformation quantization section.

2. The encoding device according to claim 1, wherein the entropy-coding section entropy-codes information on the lossless-mode QP range determined by the lossless-mode QP range determining section to generate a bitstream.

3. The encoding device according to claim 1, wherein the lossless-mode QP range determining section compares an average amount of bits necessary for lossless-mode encoding with an average amount of bits necessary for lossy-mode encoding of each QP in the course of encoding and determines the lossless-mode QP range so that one or more QPs in the lossy mode having an amount of bits greater the average amount of bits necessary for the lossless-mode encoding belong to the lossless-mode QP range.

4. The encoding device according to claim 3, wherein the lossless-mode QP range determining section determines the lossless-mode QP range so that one or more QPs in the lossy mode having rate-distortion cost greater than that in the lossless mode belong to the lossless-mode QP range.

5. The encoding device according to claim 1, wherein the lossless-mode QP range determining section encodes a slice or frame to which the macro block in the lossless mode and the lossy mode based on one or more QP values and compares the amounts of bits thereof to determine the lossless-mode QP range.

6. The encoding device according to claim 5, wherein the mode determining section determines a mode for the macro block using the lossless-mode QP range, and wherein the transformation and quantization section performs or skips the transformation and quantization on the macro block depending on the mode determined by the mode determining section.

7. The encoding device according to claim 1, wherein the mode determining section redefines a QP table by removing the lossless-mode QP range and determines the mode on the basis of the redefined QP table.

8. The encoding device according to claim 7, wherein the mode determining section rearranges a QP range in the lossy mode on the basis of the redefined QP table and determines the mode using the rearranged QP table.

9. The encoding device according to claim 1, wherein the input image is an H.264/AVC image in which a lossy-mode area and a lossless-mode area coexist.

10. A decoding device comprising:
an entropy-decoding section that receives and entropy-decodes a bitstream including lossless-mode QP range information and a residual signal;
a lossless-mode QP range determining section that determines a lossless-mode QP range on the basis of the decoded lossless-mode QP range information;
a mode determining section that compares a QP value of the bitstream with the lossless-mode QP range determined by the lossless-mode QP range determining section to determine one of a lossy mode and a lossless mode;
an inverse transformation and quantization section that performs or skips inverse transformation and inverse quantization on the entropy-decoded residual signal depending on the mode determined by the mode determining section; and
a compensation section that adds a predicted value resulting from one or more of spatial compensation and temporal compensation to the residual signal output from the inverse transformation and inverse quantization section to generate a reconstructed image.

11. The decoding device according to claim 10, wherein the reconstructed image is an H.264/AVC image in which a lossy-mode area and a lossless-mode area coexist.

12. An encoding method in an encoding device that encodes an input image to generate a bitstream, comprising:
generating a residual signal which is a difference between an input image and prediction values acquired by performing one or more of temporal prediction and spatial prediction on macro blocks of the input image;
performing or skipping transformation and quantization on the residual signal depending on mode information;
entropy-coding the resultant residual signal to generate a bitstream;
determining a lossless-mode QP range using an amount of bits generated in the step of entropy-coding and a quantization coefficient (QP); and
comparing a current QP value with the determined lossless-mode QP range to determine one of a lossy mode and a lossless mode and transmitting information on the determined mode to the transformation quantization section.

13. The encoding method according to claim 12, further comprising a step of entropy-coding information on the lossless-mode QP range to generate a bitstream.

14. The encoding method according to claim 14, wherein the step of determining the lossless-mode QP range includes comparing an average amount of bits necessary for lossless-mode encoding with an average amount of bits necessary for lossy-mode encoding of each QP in the course of encoding and determining the lossless-mode QP range so that one or more QPs in the lossy mode having an amount of bits greater the average amount of bits necessary for the lossless-mode encoding belong to the lossless-mode QP range.

15. The encoding method according to claim 14, wherein the step of determining the lossless-mode QP range includes determining the lossless-mode QP range so that one or more QPs in the lossy mode having rate-distortion cost greater than that in the lossless mode belong to the lossless-mode QP range.

16. The encoding method according to claim 12, wherein the step of determining the lossless-mode QP range includes encoding a slice or frame to which the macro block in the lossless mode and the lossy mode based on one or more QP values and comparing the amounts of bits thereof to determine the lossless-mode QP range.

17. The encoding method according to claim 16, wherein the step of determining a mode includes determining a mode for the macro block using the lossless-mode QP range, and
wherein the step of performing or skipping transformation and quantization and the step of entropy-coding are finally performed on the macro block.

18. The encoding method according to claim 12, wherein the step of determining a mode includes redefining a QP table by removing the lossless-mode QP range and determining the mode on the basis of the redefined QP table.

19. The encoding method according to claim 18, wherein the step of determining a mode includes rearranging a QP range in the lossy mode on the basis of the redefined QP table and determining the mode using the rearranged QP table.

20. The encoding method according to claim 12, wherein the input image is an H.264/AVC image in which a lossy-mode area and a lossless-mode area coexist.

21. A decoding method in a decoding device that receives and decodes a bitstream including lossless-mode QP range information and a residual signal to generate a reconstructed image, comprising the steps of:
entropy-decoding the bitstream;
determining a lossless-mode QP range on the basis of the entropy-decoded lossless-mode QP range information;
comparing a QP value of the bitstream with the determined lossless-mode QP range to determine one of a lossy mode and a lossless mode;
performing or skipping inverse transformation and inverse quantization on the decoded residual signal depending on the determined mode; and
adding a predicted value resulting from one or more of spatial compensation and temporal compensation to the residual signal having been subjected to the step of performing or skipping inverse transformation and inverse quantization to generate a reconstructed image.

22. The decoding method according to claim 21, wherein the reconstructed image is an H.264/AVC image in which a lossy-mode area and a lossless-mode area coexist.
